(19) United States
(12) Patent Application Publication
(10) Pub. No.: US 2019/0337666 A1
(43) Pub. Date: Nov. 7, 2019

(54) Sleeve Blank, Package Sleeve, Package and Method for Manufacturing a Sleeve Blank, a Package Sleeve and a Package

(71) Applicant: SIG Technology AG, Neuhausen am Rheinfall (CH)

(72) Inventors: Matthias Dammers, Alsdorf (DE); Christoph Wirtz, Linnich (DE)

(21) Appl. No.: 16/087,859

(22) PCT Filed: Mar. 16, 2017
(86) PCT No.: PCT/EP2017/056201

§ 371 Date: Sep. 24, 2018

(30) Foreign Application Priority Data
Apr. 4, 2016 (DE) 10 2016 003 827.6

(51) Int. Cl. B65D 5/02; B65D 5/06; B32B 7/12; B65D 5/42; B65D 5/22; B65D 5/56

(52) U.S. Cl. CPC B65D 5/0227; B65D 5/064; B65D 5/0209; B65D 5/40; B65D 5/4266; B65D 5/22; B65D 5/56; B32B 7/12

(57) ABSTRACT

Provided is a sleeve blank which includes a first polymer layer; a support layer on the polymer layer; a barrier layer on the support layer; and adhesive layer on the barrier layer; and a second polymer layer following on the adhesive layer facing a second outer side. At least a part of the layers are deformed through at least one first and one second crease line, each possessing starting an end points. Each crease line runs along an imaginery line which corresponds to the respective crease line, and projects beyond its beginning and/or end through imaginary continuation thereof. The crease lines separate regions forming sleeve, gable and base surfaces. The sleeve blank includes at least one point of intersection of imaginery lines and is free of any point of intersection of the crease lines, at least in the forming sleeve surfaces, gable surfaces, and/or base surfaces.

The present invention relates to a sleeve blank which contains as composite components at least:
a first polymer layer facing a first outer side;
a support layer on the outer polymer layer, following in the direction of a second outer side;
a barrier layer on the support layer, following in the direction of the second outer side;
an adhesive layer on the barrier layer, following in the direction of the second outer side; and
a second polymer layer following on the adhesive layer which faces a second outer side,
wherein the layers, or at least a part of the layers, are deformed in certain regions through at least one first and one second crease line, in each case possessing a starting point and an end point,
wherein each crease line runs along an imaginary line associated therewith which, in terms of its respective location and its course on the sleeve blank, corresponds to the respective crease line, and projects beyond its beginning and/or its end through imaginary continuation of said course, and
wherein the crease lines separate regions forming sleeve, gable, and base surfaces from one another.

The invention relates to a package sleeve made of a composite material for the manufacture of a package comprising:
a sleeve surface, and
a longitudinal seam which connects two edges of the composite material to form a circumferential package sleeve.

The invention relates to a package made of a composite material comprising:
a sleeve surface, and
a longitudinal seam which connects two edges of the composite material to form a circumferential package sleeve,
a first transverse seam which connects two edges of the composite material in a base region and
a second transverse seam which connects two edges of the composite material in a gable region.

The invention relates to a method for manufacturing a sleeve blank from a composite material.

The invention relates to a method for manufacturing a package sleeve from a sleeve blank.

The invention relates to a method for manufacturing a package from a package sleeve.

Packages can be manufactured in different ways and from an extremely wide range of materials. A widely used possibility for their manufacture consists of producing a sleeve blank from the package material from which, through folding and further steps, first a package sleeve and finally a package is produced. This manufacturing method has the advantage, among others, that the sleeve blanks and package sleeves are very flat and can thus be stacked, saving space. In this way, the sleeve blanks or package sleeves can be manufactured in a different location to that where the folding and filling of the package sleeves takes place. Composite materials are frequently used as material, for example a composite material consisting of several thin layers of paper, paperboard, plastic or metal, in particular aluminium. Such packages are widely used in the foodstuffs industry in particular.

First, the package material, which is produced as a roll product through multiple lamination of a paper, paperboard or cardboard web with thin layers of plastic and/or metal, is formed into a sleeve blank by impressing a fold pattern, with subsequent longitudinal and transverse cutting.

A manufacturing step which usually follows immediately frequently involves producing a circumferential package sleeve from a sleeve blank through folding and welding or adhesive bonding of a seam. The folding of the sleeve blank usually takes place along the aforementioned impressed or stamped fold lines. The location of the fold lines thereby corresponds to the location of the edges of the package which is to be produced from the package sleeve. This has the advantage that the sleeve blank and the package sleeve are exclusively folded at points at which the finished package is folded in any case. In the context of the present specification, a sleeve blank therefore refers to a sheet, manufactured from a composite material product produced on a roll, cut to size in a longitudinal and transverse direction and with a defined outline (“planar composite”). A package sleeve is subsequently manufactured from the sheet or planar composite and finished ready for sale, wherein a package sleeve is regarded as being ready for sale if, possibly following removal from an outer packaging provided for transport from the place of manufacture to the place of use, it is ready for processing in a filling machine intended for this purpose. This means in particular that the package sleeve requires no further mechanical interventions in order to guarantee smooth processing of the package sleeve on the filling machine intended for this purpose. In contrast, conditioning to the outer atmosphere and/or (additional) sterilisation (for example the applicant's edge sterilisation method) can also be carried out, optionally, on a finished package sleeve during or following transport to the intended place of use. On the other hand, intermediate steps occurring during the manufacture of the package sleeve from a sleeve blank involving forming and sealing cannot yet be described as relating to a package sleeve.

In addition to providing a package sleeve of the kind described above, a method for manufacturing a package involves unfolding the package sleeve, forming the package sleeve into a package sealed at one end, which at this stage is referred to by the skilled person as a “beaker”, sterilisation of the interior of the resulting package, filling, sealing, generally by means of a sealing operation, final forming of the package by folding-in folding projections and possible application of an opening aid (“cap”) and/or drinking aid (“straw”). An example of a method for manufacturing a package from a package sleeve is described in DE 19 945 500 A1.

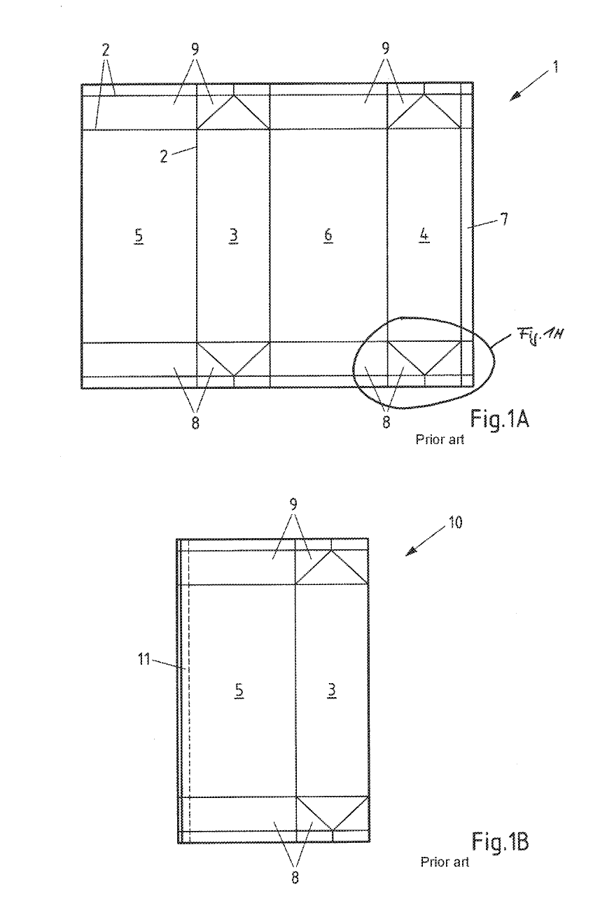

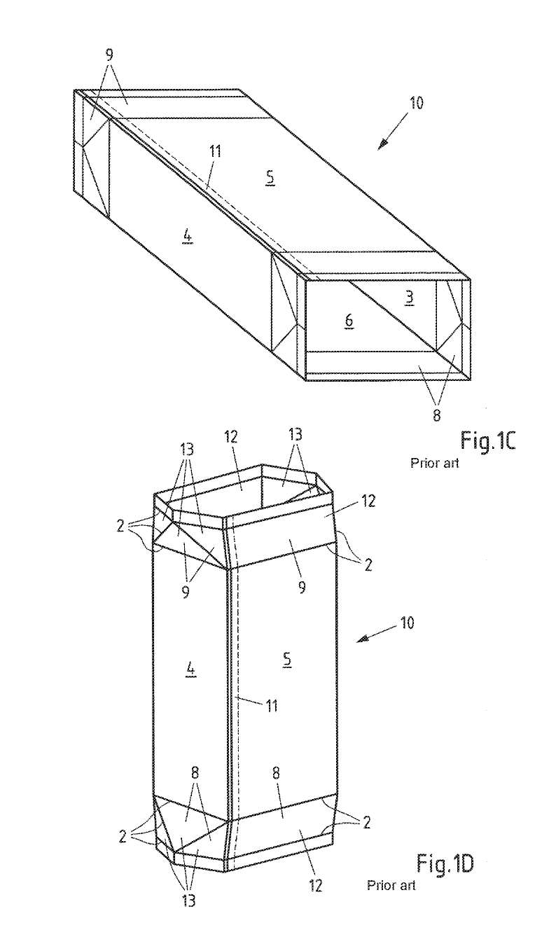

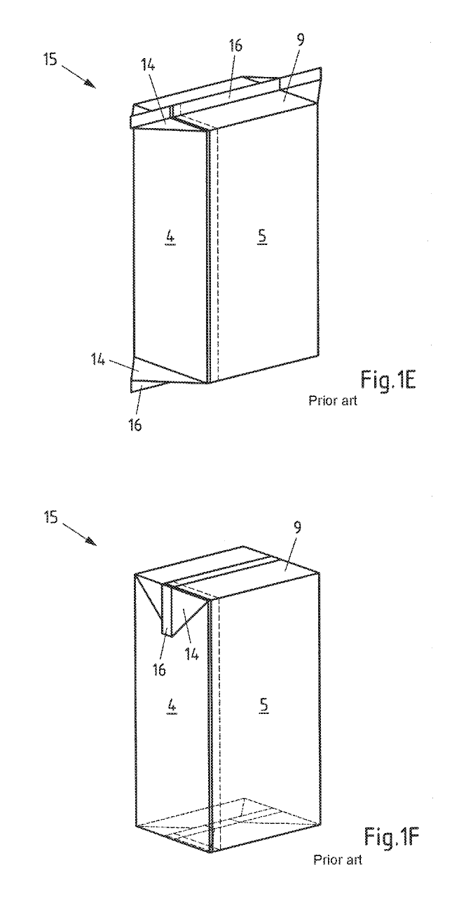

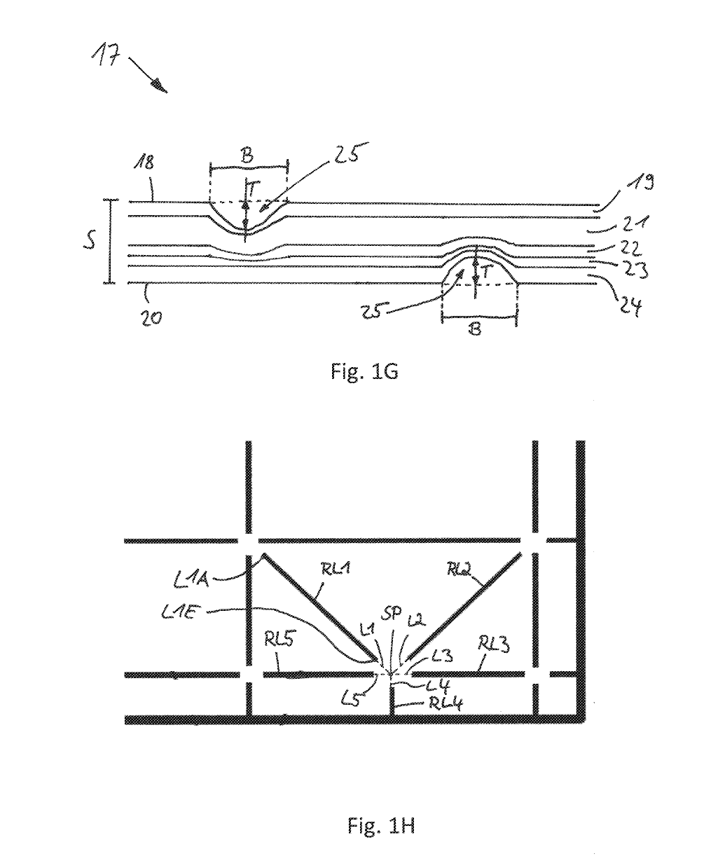

A further method for manufacturing a package from a package sleeve is for example known from WO 2015/003852A9 (in particular, FIG. 1A to FIG. 1E). This method differs from the disclosed method for example in that the side of the package sleeve forming the interior of the package is sterilised prior to forming the beaker (i.e. before sealing the base). The package described therein has a rectangular cross-sectional profile and is generally cuboid in form.

As well as packages with rectangular cross-sectional profiles, packages are also known with cross-sectional profiles which have more than four corners. For example, packages with octagonal cross-sectional profile are known from EP 0 936 150 B1 or U.S. Pat. No. 6,042,527. The form of the packages is achieved in that additional fold lines are provided in the sleeve blanks.

However, one disadvantage of folding the described package sleeves along the later package edges is that only packages with tangular cross-sectional profiles can be manufactured. Moreover, only packages with a cross-sectional profile which remains identical in the vertical direction of the package can be manufactured. In contrast, alternative designs, for example rounded edges or free forms instead of the edges, are not possible.

Package sleeves (“sleeves”) and packages manufactured from these (“containers”) are also known from EP 0 027 350 A1. The package sleeve described therein allows packages to be manufactured the cross-sectional profile of which changes in a vertical direction (rectangular cross-sectional profiles on the gable and at the base, octagonal cross-sectional profile in between). However, this package too has exclusively angular cross-sectional profiles. Alternative designs, for example rounded edges or free forms instead of the edges, are also not described in EP 0 027 350 A1. Moreover, the package sleeve described therein does not consist of composite material, but of paperboard or corrugated board. In order to fill the container with liquid, an inner pouch made of plastic is suggested, so that the package sleeve itself need not itself be suitable for manufacturing a liquid-tight package.

Package sleeves and packages manufactured from these are also described in GB 808,223 A. Here, a long material web of paperboard is first provided with fold lines and then covered with a plastic layer (FIG. 6). After creating a longitudinal seam (FIG. 7), the material web is opened up to form a tube with a rectangular cross section (FIG. 8). The two side surfaces of the tube are then folded inwards, as a result of which the tube assumes a flat form (FIG. 9). Transversely oriented seams are created at specific intervals, along which the tube can be folded and a stack thus formed (FIG. 10). By separating the tube in the region of the transversely oriented seams, individual package sleeves are obtained which are already sealed at one end—through the transversely oriented seam. One disadvantage of this approach is that the package sleeves are already folded along six fold lines on being separated from the tube, four of these fold lines forming the edges of the later package. These package sleeves too are therefore only suitable for manufacturing packages with rectangular cross-sectional profiles. Moreover, the freedom of design of the gable or base surface created in the region of the already sealed transverse seam are severely limited. Particularly disadvantageous are the high forming forces which are necessary in order to open up and form the package sleeve into a package open at one end (this intermediate state is also described as a “beaker”). The high forming forces lead to a considerable load on the already-sealed seams, so that a liquid- and/or gas-tightness is no longer provided with adequate certainty.

A further package sleeve and a package manufactured from this are described in WO 97/32787 A2. However, in this package sleeve too, numerous fold lines are provided in the region of the sleeve surface, some of which form the later edges of the package produced from this. These package sleeves too are therefore only suitable for the manufacture of packages with rectangular cross-sectional profiles. A further disadvantage is that the package sleeve is not only sealed in the region of the rear side through a longitudinal seam, but is also already sealed in the region of the base through a transverse seam. This leads to a limited freedom of design of the base. Here too, the high forming forces which are necessary in order to open up and form the package sleeve into a package open at one end are particularly disadvantageous. The high forming forces lead to a considerable load on the already-sealed seams, so that a liquid- and/or gas-tightness is no longer provided with adequate certainty. Also disadvantageous is the limitation that only one base variant (lugs folded beneath the base) is possible, whereas a different base variant (lugs directed inwards above the base) is not possible.

The present invention relates to a sleeve blank which contains as composite components at least:
a first polymer layer facing a first outer side;
a support layer on the outer polymer layer, following in the direction of a second outer side;
a barrier layer on the support layer, following in the direction of the second outer side;
an adhesive layer on the barrier layer, following in the direction of the second outer side; and
a second polymer layer following on the adhesive layer which faces a second outer side,
wherein the layers, or at least a part of the layers, are deformed in certain regions through at least one first and one second crease line, in each case possessing a starting point and an end point,
wherein each crease line runs along an imaginary line associated therewith which, in terms of its respective location and its course on the sleeve blank, corresponds to the respective crease line, and projects beyond its beginning and/or its end through imaginary continuation of said course, and
wherein the crease lines separate regions forming sleeve, gable, and base surfaces from one another,

characterised in that the sleeve blank comprises at least one point of intersection of imaginary lines and is free of any point of intersection of the crease lines, at least in the region forming sleeve surfaces and/or in the region forming gable surfaces and/or in the region forming base surfaces, or is completely free thereof.

A point of intersection in terms of this application also includes a point of contact.

This has the advantage that, during the manufacture of a package sleeve formed from the sleeve blank, said sleeve blank can be formed readily along the crease lines, and in particular with minimal stress in the material concentrations formed in the region surrounding the points of intersection.

The deformation associated with the crease lines in the sleeve blank takes place in particular through material displacement.

Preferably, the beginning and/or end points of the crease lines are thereby between 0.1 mm and 10.0 mm, preferably between 0.4 mm and 6.5 mm, most preferably between 0.5 mm and 3.8 mm distant from a point of intersection formed by the imaginary lines associated with the crease lines.

In this way, when folding the sleeve blank during the manufacture of the package sleeve created therefrom, or during the later folding of the finished package sleeve in order to manufacture a package created therefrom, a bursting or delamination of the composite material in the areas to be folded can be prevented, particularly reliably, without having to accept a high risk of folding defects.

The present invention also relates to a sleeve blank which contains as composite components at least:
a first polymer layer facing a first outer side;
a support layer on the outer polymer layer, following in the direction of a second outer side;
a barrier layer on the support layer, following in the direction of the second outer side;
an adhesive layer on the barrier layer, following in the direction of the second outer side;
a second polymer layer following on the adhesive layer which faces a second outer side
wherein the layers, or at least a part of the layers, are deformed by material displacement in certain regions through at least one first and one second crease line, in each case possessing a starting point and an end point,
wherein each crease line runs along an imaginary line associated therewith which, in terms of its respective location and its course on the sleeve blank, corresponds to the respective crease line, and projects beyond its beginning and/or its end through imaginary continuation of said course,

characterised in that

the sleeve blank includes at least one crease line which has realised a material displacement in the direction from the first outer side towards the second outer side, and at least one crease line which has realised a material displacement in the direction from the second outer side towards the first outer side.

This has the advantage that the direction of the material displacement can be adapted to the later folding direction. In this way too, when folding the sleeve blank during the manufacture of the package sleeve created therefrom, or during the later folding of the finished package sleeve in order to manufacture a package created therefrom, a bursting or delamination of the composite material in the areas to be folded can be prevented, particularly reliably, without having to accept a high risk of folding defects.

Advantageously, this sleeve blank is combined with features of the sleeve blank described above, which includes at least one point of intersection of imaginary lines and is free of a point of intersection of the crease lines and/or its various embodiments.

In this way, a bursting or delamination of the composite material in the areas to be folded can be prevented, particularly reliably.

It is also advantageous if one of the aforementioned sleeve blanks has crease lines with a width in the range between 0.7 mm and 3.2 mm, in particular between 1.0 mm and 2.5 mm and most particularly between 1.2 mm and 2.2 mm.

Crease lines of such widths minimise damage to the fibres of the cardboard-based composite material.

It is thereby particularly advantageous if at least the crease lines on the sleeve blank which run in the same direction are of at least roughly the same width. Moreover, it is quite particularly advantageous if any secondary creases which are present also have the same width as the crease lines. It is also quite particularly advantageous if any auxiliary creases which are present also have the same width.

In this way, a width can be chosen which is exactly matched to the material properties of the laminate or of the composite structure.

For the same reason it can also be advantageous if all crease lines have the same width, irrespective of whether they run in a longitudinal, diagonal, or transverse direction, or whether they are free-form crease lines.

On the other hand, in other cases it can be advantageous if a group of lines have a different width from other lines, depending on their orientation or their classification.

This allows the lines to better fulfil their different functions.

In this case the widths can for example differ by 0.1 mm to 0.5 mm.

It is also advantageous if one of the aforementioned sleeve blanks has crease lines with a depth of penetration in the range between 10% and 120%, in particular between 15% and 90% and most particularly between 20% and 60%.

Such depths of penetration of the crease lines minimise damage to the fibres of the cardboard-based composite material.

It is thereby particularly advantageous if at least the crease lines on the sleeve blank which run in the same direction have at least roughly the same the same depth of penetration. Moreover, it is quite particularly advantageous if any secondary creases which may be present also have the same depth of penetration as the crease lines. It is also quite particularly advantageous if any auxiliary creases which may be present also have the same depth of penetration.

In this way, a depth of penetration can be chosen which is exactly matched to the material properties of the laminate or of the composite structure.

For the same reason it can also be advantageous if all crease lines have the same depth of penetration, irrespective of whether they run in a longitudinal, diagonal, or transverse direction, or whether they are free-form crease lines.

On the other hand, in other cases it can be advantageous if a group of lines have a different depth of penetration from other lines, depending on their orientation or their classification.

This allows the lines to better fulfil their different functions.

In this case the depths of penetration can for example differ by 5% to 25% of the total thickness of the composite material or laminate.

It is advantageous if the depth of penetration of at least one line is, in its regions adjacent to its beginning and/or end point, for up to to 10.0 mm, preferably up to 4.8 mm, most preferably up to 3.8 mm reduced in sections by at least 15%, in particular by at least 30%, most particularly by at least 50%.

This prevents inner notch effects within the composite material. At the same time however, the folding still extends sufficiently far.

It is advantageous if the sleeve blank has at least one point of intersection with 2 to 8 participating imaginary lines.

This makes possible a wide variability in form of the package sleeves which can be formed from the sleeve blank and of the packages which can be formed from the package sleeves.

It is thereby advantageous if at least one of the participating lines is a crease line.

It is also advantageous if at least one of the participating lines is a secondary crease line.

It is also advantageous if at least one of the participating lines is an auxiliary crease line.

The invention also relates to a package sleeve created from one of the sleeve blanks.

The invention also relates to a package created from such a package sleeve.

The invention also relates to corresponding manufacturing methods.

The invention is explained in more detail in the following with reference to a drawing which simply represents a preferred exemplary embodiment. In the drawing:

FIG. 1A: shows a sleeve blank intended for folding into a package sleeve known from the prior art,

FIG. 1B: shows a package sleeve known from the prior art, formed from the sleeve blank shown in FIG. 1A, in the flat folded state,

FIG. 1C: shows the package sleeve from FIG. 1B in the unfolded state,

FIG. 1D: shows the package sleeve from FIG. 1C with pre-folded base and gable surfaces,

FIG. 1E: shows a package, known from the prior art, which is formed from the sleeve blank shown in FIG. 1A, after welding,

FIG. 1F: shows the package from FIG. 1E with folded-in lugs,

FIG. 1G: shows a composite material 17 used as the basis for a sleeve blank 1 in cross section, and

FIG. 1H: shows an enlarged view of the area of the sleeve blank 1 circled in FIG. 1A.

FIG. 1A shows a sleeve blank 1, known from the prior art, from which a package sleeve can be formed. The sleeve blank 1 can, as shown in in FIGS. 1G and 1H, comprise several layers of different materials, for example paper, paperboard, plastic or metal, in particular aluminium. The sleeve blank 1 has several fold lines 2 which are intended to facilitate the folding of the sleeve blank 1 and which divide the sleeve blank 1 into several surfaces. The sleeve blank 1 can be divided into a first side surface 3, a second side surface 4, a front surface 5, a rear surface 6, a sealing surface 7, base surfaces 8 and gable surfaces 9. A package sleeve can be formed from the sleeve blank 1 in that the sleeve blank 1 is folded such that the sealing surface 7 can be connected, in particular welded, with the front surface 5.

FIG. 1B shows a package sleeve 10 known from the prior art in the flat folded state. The regions of the package sleeve already described in connection with FIG. 1A are provided with corresponding reference numbers in FIG. 1B. The package sleeve 10 is formed from the sleeve blank 1 shown in FIG. 1A. For this purpose, the sleeve blank 1 has been folded such that the sealing surface 7 and the front surface 5 are arranged so as to overlap, so that the two surfaces can be surface-welded together. As a result, a longitudinal seam 11 is created. FIG. 1B shows the package sleeve 10 in a flat folded-up state. In this state, a side surface 4 (concealed in FIG. 1B) lies beneath the front surface 5 while the other side surface 3 lies on the rear surface 6 (concealed in FIG. 1B). In the flat folded-up state, several package sleeves 10 can be stacked in a particularly space-saving manner. Therefore, the package sleeves 10 are frequently stacked at the place of manufacture and transported in stacked form to the location where filling takes place. Only there are the package sleeves 10 unstacked and unfolded, usually already within a filling machine, so that they can be filled with contents, for example with foodstuffs. The filling can take place under aseptic conditions.

FIG. 1C shows the package sleeve 10 from FIG. 1B in the unfolded state. Here too, the regions of the package sleeve 10 already described in connection with FIG. 1A or FIG. 1B are provided with corresponding reference numbers. The unfolded state refers to a configuration in which an angle of around 90° is formed between the two in each case adjacent surfaces 3, 4, 5, 6, so that the package sleeve 10 assumes a square or rectangular cross section, depending of the shape of these surfaces. Accordingly, the opposite side surfaces 3, 4 are arranged parallel to one another. The same applies to the front surface 5 and the rear surface 6.

FIG. 1D shows the package sleeve 10 from FIG. 1C in the pre-folded state, i.e. in a state in which the fold lines 2 have been pre-folded both in the region of the base surfaces 8 as well as in the region of the gable surfaces 9. Those regions of the base surfaces 8 and the gable surfaces 9 which adjoin the front surface 5 and the rear surface 6 are also referred to as rectangular surfaces 12. The rectangular surfaces 12 are folded inwards during the pre-folding and later form the base or the gable of the package. Those regions of the base surfaces 8 and the gable surfaces 9 which adjoin the side surfaces 3, 4 are, in contrast, referred to as triangular surfaces 13. The triangular surfaces 13 are folded outwards during the pre-folding and form projecting regions of surplus material which are also referred to as “lugs” 14 and in a later manufacturing step are folded and fixed against the package, for example using an adhesive bonding process.

FIG. 1E shows a package 15 known from the prior art which is formed from the sleeve blank shown in FIG. 1A. The package 15 is shown after welding, i.e. in the filled and sealed state. After sealing, a fin seam 16 is created in the region of the base surfaces 8 and in the region of the gable surfaces 9. In FIG. 1E the lugs 14 and the fin seam 16 project. Both the lugs 14 and also the fin seam 16 are folded flat in a later manufacturing step, for example by means of a welding process, in particular one comprising activation and pressing.

FIG. 1F shows the package 15 from FIG. 1E with folded-in lugs 14. Moreover, the fin seams 16 are also folded flat against the package 15. The upper lugs 14 arranged in the region of the gable surface 9 are folded downwards and fixed flat against the two side surfaces 3, 4. Preferably, the upper lugs 14 are adhesively bonded or welded to the two side surfaces 3, 4. The lower lugs 14 arranged in the region of the base surface 8 are folded downwards, but are fixed flat against the underside of the package 15, which is formed by two rectangular surfaces 12 of the base surface 8. Preferably, the lower lugs 14 are also adhesively bonded or welded together with the package 15—in particular with the rectangular surfaces 12.

FIG. 1G shows a composite material 17 used as the basis for a sleeve blank 1 in cross section. The composite material 17 comprises as composite components at least a first polymer layer 19 facing a first outer side 18, a support layer 21 on the outer polymer layer, following in the direction of a second outer side 20, a barrier layer 22 on the support layer 21, following in the direction of the second outer side 20, an adhesive layer 23 on the barrier layer 22, following in the direction of the second outer side 20, and a second polymer layer 24 following on the adhesive layer 23 which faces the second outer side 20. The support layer 21 is thereby formed from a pulp-based material, in particular from a layer of cardboard, and has a grammage or weight of between 120 g/m² and 400 g/m². The barrier layer 22 can be formed from a thin metallic foil, in particular an aluminium foil. Alternatively, however, the composite material 17 can also be formed free of metal, in particular aluminium.

A part of the layers 19, 21, 22, 23, 24 is deformed in certain regions through at least one first and one second crease line 25. The total thickness S of the composite material 17 can preferably be between 0.15 mm and 1.0 mm, particularly preferably between 0.2 mm and 0.6 mm, and is substantially dependent on which volume the package, formed from the package sleeve formed from the sleeve blank, is intended to contain. Nowadays, usual volumes of ready-for-sale packages of preferably aseptically-filled foodstuffs, in particular beverages, range between 50 ml and 4000 ml. The greater the volume, the thicker the composite material 17 needs to be. The depth T of the crease line 25 (measured at its deepest point) follows the indentation produced through the stamping or material displacement and amounts to around 10% to 120%, particularly preferably between 20% and 60% of the total thickness S of the composite material 17.

FIG. 1H shows an enlarged view of the area of the sleeve blank 1 circled in FIG. 1A. It can be seen that the first crease line RL1 and the second crease line RL2 as well as the further crease lines shown, RL3, RL4, RL5, in each case run along an imaginary line L1, L2, L3, L4, L5 associated therewith which, in terms of its respective location and its course on the sleeve blank, corresponds to the respective crease line, and projects beyond its beginning and/or its end through imaginary continuation of said course. A starting point L1A and an end point L1E are, by way of example, identified in the figure in connection with the line L1.

The point of intersection SP, on the sleeve blank 1, of imaginary lines L1, L2, L3, L4, L5 examined in more detail in FIG. 1H is thereby free of a point of intersection of the crease lines RL1, RL2, RL3, RL4, RL5, each lying, at least in sections, on the participating imaginary lines L1, L2, L3, L4, L5. In the case illustrated, the distance of the end regions of the crease lines RL1, RL2, RL3, RL4, RL5 from the point of intersection SP of the imaginary lines L1, L2, L3, L4, L5 is between 0.4 mm and 4.5 mm.

### LIST OF REFERENCE NUMERALS

1: sleeve blank

2: fold line

3, 4: side surface

5: front surface

6: rear surface

7: sealing surface

8: base surface

9: gable surface

10: package sleeve

11: longitudinal seam

12: rectangular surface

13: triangular surface

14: lug

15: package

16: fin seam

17: composite material

18: first outer side

19: first polymer layer

20: second outer side

21: support layer

22: barrier layer

23: adhesive layer

24: second polymer layer

25: crease line

B: width (of the crease line 25)

L1-L5: line

L1A: starting point

L1E: end point

RL1-RL5: crease line

S: total thickness (of the composite material 17)

SP: point of intersection

T: depth (of the crease line 25

1. A sleeve blank which contains as composite components at least:
a first polymer layer facing a first outer side;
a support layer on the outer polymer layer, following in the direction of a second outer side;
a barrier layer on the support layer, following in the direction of the second outer side;
an adhesive layer on the barrier layer, following in the direction of the second outer side; and
a second polymer layer following on the adhesive layer which faces a second outer side,
wherein at least a part of the layers are deformed in certain regions through at least one first and one second crease line, in each case possessing a starting point and an end point,
wherein each crease line runs along an imaginary line associated therewith which, in terms of its respective location and its course on the sleeve blank, corresponds to the respective crease line, and projects beyond its beginning and/or its end through imaginary continuation of said course,
wherein the crease lines separate regions forming sleeve, gable, and base surfaces from one another,
wherein the sleeve blank comprises at least one point of intersection of imaginary lines and is free of any point of intersection of the crease lines, at least in the region forming sleeve surfaces and in the region forming gable surfaces and in the region forming base surfaces, or is completely free thereof.

2. A sleeve blank which contains as composite components at least:
a first polymer layer facing a first outer side;
a support layer on the outer polymer layer, following in the direction of a second outer side;
a barrier layer on the support layer, following in the direction of the second outer side;
an adhesive layer on the barrier layer, following in the direction of the second outer side;
a second polymer layer following on the adhesive layer which faces a second outer side
wherein at least a part of the layers,. are deformed by material displacement in certain regions through at least one first and one second crease line, in each case possessing a starting point and an end point,
wherein each crease line runs along an imaginary line associated therewith which, in terms of its respective location and its course on the sleeve blank, corresponds to the respective crease line, and projects beyond its beginning and/or its end through imaginary continuation of said course,
wherein the sleeve blank includes at least one crease line which has realised a material displacement in the direction from the first outer side towards the second outer side, and at least one crease line which has realised a material displacement in the direction from the second outer side towards the first outer side.

3. A package sleeve, wherein the package sleeve is manufactured from a sleeve blank according to claim 1.

4. (canceled)

5. A package, wherein the package is manufactured from a package sleeve according to claim 3.

6. (canceled)

7. A method for manufacturing a package sleeve comprising manufacturing the package sleeve from a sleeve blank according to claim 1.

8. A method for manufacturing a package comprising manufacturing the package from a package sleeve according to claim 3.

9. A method for manufacturing a sleeve blank comprising manufacturing the sleeve blank according to claim 1 from a composite material.

10. A package sleeve, wherein the package sleeve is manufactured from a sleeve blank according to claim 2.

11. A package, wherein the package is manufactured from a package sleeve according to claim 10.

12. A method for manufacturing a package sleeve comprising manufacturing the package sleeve from a sleeve blank according to claim 2.

13. A method for manufacturing a package comprising manufacturing the package from a package sleeve according to claim 10.

14. A method for manufacturing a sleeve blank comprising manufacturing the sleeve blank according to claim 2 from a composite material.
